(19) United States
(12) Patent Application Publication
(10) Pub. No.: US 2010/0264376 A1
(43) Pub. Date: Oct. 21, 2010

(54) Process for preparing an elastomeric composite material with a high content of nanotubes

(75) Inventors: Alexander Korzhenko, Pau (FR); Amelie Merceron, Aussevielle (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: ARKEMA FRANCE, Colombes (FR)

(21) Appl. No.: 12/728,689

(22) Filed: Mar. 22, 2010

Related U.S. Application Data
(60) Provisional application No. 61/235,463, filed on Aug. 20, 2009.

(30) Foreign Application Priority Data
Mar. 23, 2009 (FR) 0951840

(51) Int. Cl. H01B 1/24

(52) U.S. Cl. 252/511

(57) ABSTRACT

The present invention relates to a process for preparing, in a co-kneader, a composite material containing a thermosetting elastomeric resin base and carbon nanotubes.

It also relates to the composite material thus obtained and to its use for manufacturing composite products.

The present invention relates to a process for preparing a composite material containing an elastomeric thermosetting resin base and carbon nanotubes, and also to the composite material thus obtained and to its use for manufacturing composite products.

Elastomers are polymers endowed with rubbery elasticity properties, which find application in many fields, including the manufacture of motor vehicle components such as tires, seals or tubes, and the pharmaceutical, electrical, transportation or construction industry, for example. In some of these applications, it may be advantageous to give them electrical conduction properties and/or to improve their mechanical properties. To do this, it is possible to incorporate therein conductive fillers such as carbon nanotubes (or CNTs).

Along these lines, document WO 2007/035442 describes a process for incorporating from 0.1% to 30% by weight and preferably from 0.1% to 1% by weight of CNT into a liquid or solid silicone resin base, which consists in dispersing these CNTs in the resin base with the aid of standard mixing devices, roll mills or ultrasonication. Example 7 of the said document more specifically discloses a masterbatch containing 25% by weight of CNT, prepared by dispersing the CNTs in a silicone resin base with the aid of a Waring mixer (knife mixer). The masterbatch obtained is in the form of a wet loose powder.

The technique proposed in the said document does not, itself either, make it possible to disperse amounts greater than 25% by weight of fillers with an apparent density as low as that of CNTs. In particular, it is not possible to incorporate these amounts of CNT into the resins without substantially forming aggregates of more than 10 μm thereof, given their naturally highly entangled structure. This poor dispersion of the CNTs leads to embrittlement of the composites formed therefrom, which is reflected especially in the appearance of nanocracks. In addition, the masterbatch obtained according to the abovementioned document is in powder form, which is not particularly easy to handle.

Another solution for obtaining CNT-charged elastomers consists in mixing the CNTs and thermoplastic elastomers, in the presence of plasticizers. These plasticizers may especially be mixed with the nanotubes in the form of a precomposite, which is then diluted in the elastomeric matrix (FR 2 916 364). The precomposites illustrated in the said document are prepared in a compounding device such as a BUSS® co-kneader. However, they do not contain more than 5% by weight of CNT at most. Thus, it is not suggested that the abovementioned compounding device can enable more than 5% by weight of CNT to be incorporated into an elastomeric base, and all the less so into a thermosetting elastomeric resin base, even in the absence of plasticizer.

Other documents (WO 2006/079060, WO 2007/063253, WO 2005/081781, WO 2009/030358, WO 03/085681, WO 2006/072741, WO 2007/035442, WO 2008/025962,JP 2008 163 219, US 2007/213450) disclose processes for mixing CNTs with a thermoplastic or thermosetting elastomeric resin base.

There is still however a need for a means for simply and uniformly dispersing, at the industrial scale, more than 5% CNT in a thermosetting elastomeric resin base, for the manufacture of masterbatches that can be easily handled and then diluted in a polymer matrix to form composite components.

In this context, the Applicant has discovered that it is possible to formulate composites, and in particular masterbatches, based on thermosetting elastomers, by introducing a liquid composition containing a thermosetting elastomeric resin base, in a co-kneader, in which it is blended with nanotubes.

The present invention thus relates to a process for preparing a composite material containing from more than 5% by weight, and up to 70% by weight, of nanotubes, comprising:
(a) the introduction, in a co-kneader:
   of a liquid polymer composition containing at least one elastomeric resin base, which includes, or consists of, at least one thermosetting elastomeric resin base, and
   carbon nanotubes,
(b) kneading of the polymer composition and the nanotubes in the said co-kneader, to form a composite material,
(c) recovery of the composite material, optionally after transformation into an agglomerated solid physical form.

In the present description, the term “co-kneader” means apparatus conventionally used in the plastics industry for the melt blending of thermoplastic polymers and additives in order to produce composites. In this apparatus, which normally includes a rotor equipped with blades suitable for cooperating with teeth mounted on a stator, the polymer composition and the additives are mixed together under high shear. The melt generally leaves the apparatus in an agglomerated solid physical form, for example in the form of granules, or in the form of rods, a strip or a film.

Examples of co-kneaders that may be used according to the invention are the Buss® MDK 46 co-kneaders and those of the series Buss® MKS or MX, sold by the company Buss AG, which are all constituted of a screw shaft provided with fins, arranged in a heating sheath optionally constituted of several parts and whose inner wall is provided with kneading teeth designed to engage with the fins to produce shear of the kneaded material. The shaft is driven in rotation, and provided with an oscillating movement in the axial direction, via a motor. These co-kneaders may be equipped with a system for manufacturing granules, adapted, for example, to their outlet orifice, which may be constituted of an extrusion screw or a pump.

The co-kneaders that may be used according to the invention preferably have an L/D screw ratio ranging from 7 to 22, for example from 10 to 20.

In addition, the kneading step is generally performed at a temperature that is higher than the glass transition temperature (Tg) for amorphous polymers and than the melting point for semi-crystalline polymers. This temperature depends on the polymer specifically used and generally mentioned by the polymer supplier. By way of example, the kneading temperature may range from room temperature to 260° C., for example from 80 to 260° C., generally from 80 to 220° C., preferably from 100 to 220° C., particularly from 120 to 200° C. and more preferentially from 150 to 200° C.

The Applicant has demonstrated that this process allows the production of composite materials, especially masterbatches, that may have a high dose of nanotubes, such as CNTs, and that are easy to handle, when they are in the form of agglomerated solids, in particular in the form of granules, in the sense that they can be transported in bags or drums from the production site to the processing site. These composite materials may also be formed according to the methods conventionally used for forming thermoplastic materials, such as extrusion, injection or compression.

In the present description, the term “elastomeric resin base” means a composition containing an organic or silicone polymer which forms, after vulcanization, an elastomer capable of withstanding large deformations virtually reversibly, i.e. an elastomer that can be subjected to a uniaxial deformation, advantageously of at least twice its original length at room temperature (23° C.), for five minutes, and then recover, once the stress has been removed, its initial dimension, with a remanent deformation of less than 10% of its initial dimension.

From the structural point of view, elastomers are generally formed from polymer chains connected together to form a three-dimensional network. More specifically, a distinction is occasionally made between thermoplastic elastomers, in which the polymer chains are connected together via physical bonds, such as hydrogen bonds or dipole-dipole bonds, and thermosetting elastomers, in which these chains are connected via covalent bonds, which constitute points of chemical crosslinking. These crosslinking points are formed via vulcanization processes using a vulcanizing agent that may be chosen, for example, according to the nature of the elastomer, from sulfur-based vulcanizing agents, in the presence of dithiocarbamate metal salts; zinc oxides combined with stearic acid; optionally halogenated difunctional phenol-formaldehyde resins, in the presence of tin chloride or zinc oxide; peroxides; amines; hydrosilanes in the presence of platinum; etc.

The present invention more particularly relates to elastomeric resin bases containing, or formed from, at least one thermosetting elastomer optionally as a mixture with at least one non-reactive, i.e. non-vulcanizable, elastomer (such as hydrogenated rubbers).

The elastomeric resin bases that may be used according to the invention may especially comprise, or may even be formed from, one or more polymers chosen from: fluorocarbon or fluorosilicone polymers; nitrile resins butadiene homopolymers and copolymers, optionally functionalized with unsaturated monomers such as maleic anhydride, (meth)acrylic acid and/or styrene (SBR); neoprene (or polychloroprene); polyisoprene;

copolymers of isoprene with styrene, butadiene, acrylonitrile and/or methyl methacrylate; copolymers based on propylene and/or ethylene and especially terpolymers based on ethylene, propylene and dienes (EPDM), and also copolymers of these olefins with an alkyl (meth)acrylate or vinyl acetate; halogenated butyl rubbers; silicone resins; polyurethanes; polyesters; acrylic polymers such as poly(butyl acrylate) bearing carboxylic acid or epoxy functions; and also modified or functionalized derivatives thereof and mixtures thereof, without this list being limiting.

It is preferable according to the invention to use at least one polymer chosen from: nitrile resins, in particular acrylonitrile and butadiene copolymers (NBR); silicone resins, in particular poly(dimethylsiloxanes) bearing vinyl groups; fluorocarbon polymers, in particular hexafluoropropylene (HFP) vinylidene difluoroide (VF2) copolymers; terpolymers of hexafluoropropylene (HFP), vinylidene difluoride (VF2) and tetrafluoroethylene (TFE), wherein each monomer may represent more than 0% and up to 80% of the terpolymer and mixtures thereof.

An important characteristic of this invention is that the polymer composition containing the elastomeric resin base is in liquid form during its injection into the co-kneader, in a first zone of the co-kneader upstream from the introduction of CNT. By “liquid”, we mean that the composition is capable of being pumped into the co-kneader, i.e. that it advantageously has a dynamic viscosity ranging from 0.1 to 30 Pa·s, preferably from 0.1 to 15 Pa·s.

The measurement of dynamic viscosity is based on a general method for determining viscoelastic properties of polymers in the liquid state, the molten state or the solid state. The samples are subjected to deformation (or stress), usually sinusoidal in tension, compression, bending or twisting for solids, and shear for liquids. The response of the samples to this stress is evaluated either by the force or the resulting torque, or by the deformation when working with imposed stresses. The viscoelastic properties are thus determined in terms of modulus or viscosity, or in terms of creep or relaxation function. In flow, the samples are subjected to a series of stresses and/or deformations in order to predict their behavior according to the shear value.

For this determination, a viscoelasticity meter, comprised of the following elements, is used:

A chamber or a thermal control system (the atmosphere during the test can be either liquid and/or gaseous nitrogen or air)

A central control unit

A system for controlling the flow rate and the drying of the air and the nitrogen

A measurement head

A computer system for controlling the apparatus and processing data

“Sample holders”

The RDA2, RSA2, DSR200, ARES or RME of the manufacturer Rheometrics, or MCR301 of Anton Paar can be cited as examples of equipment that can be used.

The sample sizes are defined according to the viscosity thereof and the geometric limits of the chosen “sample holder” system.

To conduct a test and determine the dynamic viscosity of a thermosetting resin, the steps described in the manual of use of the viscoelasticity meter used will be methodologically followed. In particular, it will be ensured that the relationship between deformation and stress is linear (linear viscoelasticity).

The resin base used can itself have this viscosity either at room temperature (23° C.) or after having been heated before injection into the co-kneader to give it the desired viscosity. A person skilled in the art will know how to identify such elastomeric resin bases, as a function especially of the molecular mass of their constituent polymers. In a variant of the invention, the elastomeric resin base may be solid, for example in gum form. In this case, the polymer composition may contain, besides this base, at least one processing auxiliary in liquid or waxy form, such as a fluoro polymer, especially an optionally functionalized perfluoropolyether and/or a copolymer of vinylidene fluoride and of hexafluoropropylene.

In another variant of the invention, the elastomeric resin may be introduced in the solid form, for instance in the form of ground particles, in the co-kneader and liquified in the co-kneader by means of heat and shear before introducing the CNT.

This elastomeric resin base is mixed, in the process according to the invention, with carbon nanotubes (CNT hereinbelow). These nanotubes have particular crystal structures, of tubular, hollow and closed shape, composed of atoms regularly arranged in pentagons, hexagons and/or heptagons, obtained from carbon. CNTs are generally formed from one or more rolled-up graphene leaflets. Single-wall nanotubes (SWNT) and multi-wall nanotubes (MWNT) are thus distinguished. Double-wall nanotubes may especially be prepared as described by Flahaut et al. in Chem. Commun. (2003), 1442. Multi-wall nanotubes may be prepared, for their part, as described in document WO 03/02456. It is preferable according to the invention to use multi-wall CNTs.

The nanotubes used according to the invention usually have a mean diameter ranging from 0.1 to 200 nm, preferably from 0.1 to 100 nm, more preferentially from 0.4 to 50 nm and better still from 1 to 30 nm, and advantageously a length of more than 0.1 μm and advantageously from 0.1 to 20 μm, for example about 6 μm. Their length/diameter ratio is advantageously greater than 10 and usually greater than 100. These nanotubes thus especially comprise “VGCF” nanotubes (carbon fibers obtained by chemical vapor deposition, or Vapor-Grown Carbon Fibers). Their specific surface area is, for example, between 100 and 300 m²/g and their apparent density may especially be between 0.01 and 0.5 g/cm³ and more preferentially between 0.07 and 0.2 g/cm³. Multi-wall carbon nanotubes may comprise, for example, from 5 to 15 leaflets and more preferentially from 7 to 10 leaflets.

An example of crude carbon nanotubes is especially commercially available from the company Arkema under the trade name Graphistrength® C100.

The nanotubes may be purified and/or treated. (in particular oxidized) and/or ground before being used in the process according to the invention. They may also be functionalized via chemical methods in solution, for instance amination or reaction with coupling agents.

Grinding of the nanotubes may especially be performed with or without heating and may be performed according to the known techniques implemented in apparatus such as ball mills, hammer mills, attrition mills, knife mills, gas-jet mills or any other grinding system capable of reducing the size of the entangled network of nanotubes. It is preferred for this grinding step to be performed according to a gas-jet grinding technique and in particular in an air-jet mill.

Purification of the nanotubes may be performed by washing with a solution of sulfuric acid, or of another acid, so as to free them of any residual mineral and metallic impurities originating from their preparation process. The weight ratio of the nanotubes to sulfuric acid may especially be between 1:2 and 1:3. The purification operation may moreover be performed at a temperature ranging from 90 to 120° C., for example for a duration of 5 to 10 hours. This operation may advantageously be followed by steps of rinsing with water and drying of the purified nanotubes. Another route for purifying the nanotubes, which is intended in particular for removing the iron and/or magnesium they contain, consists in subjecting them to a heat treatment above 1000° C.

Oxidation of the nanotubes is advantageously performed by placing them in contact with a solution of sodium hypochlorite containing from 0.5% to 15% by weight of NaOCl and preferably from 1% to 10% by weight of NaOCl, for example in a weight ratio of the nanotubes to sodium hypochlorite ranging from 1:0.1 to 1:1. The oxidation is advantageously performed at a temperature below 60° C. and preferably at temperature, for a time ranging from a few minutes to 24 hours. This oxidation operation may advantageously be followed by steps of filtration and/or centrifugation, washing and drying of the oxidized nanotubes.

However, it is preferred for the nanotubes to be used in the process according to the invention in crude form.

Moreover, it is preferred according to the invention to use nanotubes obtained from starting materials of renewable origin, in particular of plant origin, as described in document FR 2 914 634.

The amount of nanotubes used according to the invention represents more than 5% by weight, and up to 70% by weight, depending on whether the desired composite material is intended to be transformed directly into a composite component or whether it is in the form of a masterbatch intended to be diluted in a polymer matrix. In the latter case, the composite material according to the invention contains, for example, from 10% to 50% by weight, preferably from 20% to 50% by weight and more preferentially from 25% to 40% by weight, or even from 30% to 40% by weight, of nanotubes relative to the total weight of the composite material.

When the masterbatch according to the invention contains at least one polymer chosen from: nitrile resins, silicone resins, fluorocarbon polymers and mixtures thereof, it preferably contains 20 to 40% by weight of carbon nanotubes with respect to the total weight of the masterbatch. In particular, when the masterbatch according to the invention includes at least one polymer of the silicon resin type, it is preferable that it contains from 30 to 40% by weight of carbon nanotubes, relative to the total weight of the masterbatch.

The nanotubes may be introduced into the co-kneader either via a feed hopper separate from the zone of injection of the elastomeric resin base, or as a mixture therewith.

The polymer composition used according to the invention may contain, besides the processing auxiliaries mentioned previously, expanders, especially preparations based on azodicarbonic acid diamine such as those sold by the company Lanxess under the trade name Genitron®. These are compounds that decompose at 140-200° C. to form, during the kneading step, cavities in the composite material that facilitate its subsequent introduction into a polymer matrix.

As a variant or in addition, the polymer composition may contain compounds for reducing the tack of the elastomeric resin base and/or for improving the formation of granules. An example of such a compound is a block acrylic copolymer such as the poly(methyl methacrylate)/poly(butyl acrylate)/poly(methyl methacrylate) triblock copolymer available from the company Arkema under the trade name Nanostrength® M52N. As a variant, it is possible to use a polystyrene/1,4-polybutadiene/poly(methyl methacrylate) copolymer also sold by the company Arkema, under the reference Nanostrength®.

The polymer composition according to the invention can thus contain 40 to 80% by weight of nitrile resin and up to 20% by weight of acrylic copolymer.

Other additives that may be used are especially: graphene-based fillers other than nanotubes (especially fullerenes), silica or calcium carbonate; UV screening agents, especially based on titanium dioxide; flame retardants; and mixtures thereof. The polymer composition may, as a variant or in addition, contain at least one solvent for the elastomeric resin base.

At the end of the process according to the invention, a composite material is obtained, which may, after cooling, be in a directly usable solid form. A subject of the invention is also the composite material that may be obtained according to the above process.

Examples of composite materials capable of being obtained according to the invention include in particular those sold by the ARKEMA company under the trade names Graphistrength® C E3-35 (containing 35% by weight of multi-wall CNT in a silicone resin); Graphistrength® C E2-40 (containing 40% by weight of multiwall CNT in a nitrile resin); and Graphistrength® C E1-20 (containing 20% by weight of multiwall CNT in a fluorocarbon polymer).

This composite material may be used in its native form, i.e. formed according to any suitable technique, especially by injection, extrusion, compression or molding, followed by a vulcanization treatment. A vulcanizing agent may have been added to the composite material during the kneading step (in the case where its activation temperature is higher than the kneading temperature). However, it is preferable for it to be added to the composite material immediately before or during its forming, so as to have more leeway in adjusting the properties of the composite.

As a variant, the composite material according to the invention may be used as a masterbatch and thus diluted in a thermoplastic polymer matrix to form a composite product after forming. In this case also, the vulcanizing agent may be introduced either during the kneading step, or (more preferentially) into the polymer matrix, i.e. during the formulation of this matrix or during the forming of same. In this embodiment of the invention, the final composite product may contain, for example, from 0.01% to 35% by weight of nanotubes, preferably from 1.5% to 20% by weight of nanotubes.

The invention also relates to the use of the composite material described previously for the manufacture of a composite product and/or for the purpose of giving a polymer matrix at least one electrical, mechanical and/or thermal property.

A subject of the invention is also a process for manufacturing a composite product, comprising:
the manufacture of a composite material according to the process described previously, and
the introduction of the composite material into a polymer matrix.

The polymer matrix generally contains at least one polymer chosen from thermosetting gradient, block, random or sequential copolymers or homopolymers. According to the invention, at least one polymer chosen from those listed previously is preferably used. Advantageously, the polymer included in the polymer matrix belongs to the same chemical class (nitrile resin, or silicone or fluorocarbon polymer resin, for example) as at least one of the polymers of the elastomeric resin base.

The polymer matrix may also contain at least one vulcanizing agent and optionally a vulcanization accelerator, as indicated previously, and also various adjuvants and additives such as lubricants, pigments, stabilizers, fillers or reinforcing agents, antistatic agents, fungicides, flame retardants and solvents.

The dilution of the composite material in the polymer matrix can be performed by any means, in particular by means of internal or conical cylinder mixers.

To improve the electrical properties of the silicone resin-based composite products, it is preferable according to the invention for the composite or masterbatch material first to be mixed with a portion of the polymer matrix and with the vulcanizing agents, until a uniform mixture is obtained, before introducing the rest of the polymer matrix, and then carrying out the molding of the composite product in the desired shape.

The composite product thus obtained may especially be used for manufacturing bodywork or leakproofing seals, tires, sound-insulating plates, static charge dissipaters, an inner conductive layer for high-tension and medium-tension cables, or anti-vibration systems such as motor vehicle shock absorbers, or alternatively in the manufacture of structural elements of bullet-proof jackets, without this list being limiting.

In view of these uses, it can be shaped by any means, in particular by extrusion, molding or injection-molding.

The invention will be understood more clearly in the light of the non-limiting and purely illustrative examples that follow.

### EXAMPLES

### Example 1

### Manufacture of a Masterbatch Containing a Nitrile Resin Base

Carbon nanotubes (Graphistrength® C100 from Arkema) and an acrylic polymer powder (Nanostrength® M52N from Arkema) were introduced into the first feed hopper of a Buss® MDK 46 co-kneader (L/D=11), equipped with an extrusion screw and a granulating device. A butadiene-acrylonitrile copolymer (Nipol® 1312V from Hallstar) was preheated to 160° C. and then injected in liquid form at 190° C. into the first zone of the co-kneader. The nominal temperature and flow rate in the co-kneader were set at 200° C. and 12 kg/hour, respectively. The screw rotation speed was 240 rpm.

An homogeneous rod was obtained at the machine outlet, which was chopped under a jet of water into granules constituted of a masterbatch containing 40% by weight of nanotubes, 55% by weight of nitrile resin and 5% by weight of acrylic copolymer. These granules were then dried at about 50° C. before being conditioned.

These granules may then be diluted in a polymer matrix containing a vulcanizing agent, and formed.

As a variant, part of the nitrile resin (from 5% to 10% by weight) may be introduced into the co-kneader in granulated or ground solid form, for example into the first feed hopper.

### Example 2

### Manufacture of a Masterbatch Containing a Silicone Elastomeric Resin Base

Carbon nanotubes (Graphistrength® C100 from Arkema) are introduced into the first feed hopper of a Buss® MDK 46 co-kneader (L/D=11) equipped with an extrusion screw and a granulating device. A linear polydimethylsiloxane containing vinyl end groups (Silopren® U10 from Momentive) is introduced at a temperature of about 40-60° C., partly into the first zone of the co-kneader and partly after the first restriction ring of the co-kneader. The kneading is performed at 90-110° C.

At the machine outlet, an homogeneous rod was obtained, which was chopped under a jet of water into granules constituted of a masterbatch containing 35% by weight of nanotubes and 65% by weight of silicon resin. These granules were then dried at about 50° C. before being conditioned.

These granules may then be diluted in a polymer matrix containing a vulcanizing agent, for example in a silicone matrix for the manufacture of leakproofing seals, or in a rubber matrix for the manufacture of tires.

### Example 3

### Manufacture of a Masterbatch Containing a Fluoro Elastomeric Resin Base

A formulation containing: 35% by weight of carbon nanotubes; 40% by weight of Viton® A100 fluoro elastomer from Du Pont, used in the form of 1-5 mm ground particles; and 25% by weight of a processing auxiliary constituted of a functionalized perfluoropolyether sold by the company Solexis under the trade name Technoflon® FPA1, was prepared in the same co-kneader as that described in Example 1.

The constituents of this formulation were all introduced into the first feed hopper of the co-kneader. After blending at 160-180° C., a rod of composite material was obtained, which was chopped into granules.

This masterbatch may be diluted in a polymer matrix at room temperature to manufacture a composite product.

### Example 4

### Manufacture of a Masterbatch Containing a Fluoro Elastomeric Resin Base

A formulation containing: 40% by weight of carbon nanotubes; 20% by weight of the same fluoro elastomer as that of Example 3; 20% by weight of liquid fluoro elastomeric resin (copolymer of vinylidene fluoride and of hexafluoropropylene) sold by the company Daikin America under the trade name Daikin® DAI-EL G101; and 20% by weight of the same processing auxiliary as that of Example 3, was prepared in the same co-kneader as that described in Example 3.

The constituents of this formulation were all introduced into the first feed hopper of the co-kneader, except for the resin, which was injected at 160° C. After blending at 160-180° C., a rod of composite material was obtained, which was chopped into granules.

This masterbatch may be diluted in a polymer matrix, especially a PVDF-based matrix, to manufacture a composite product. As a variant, it may be used in its native form for the manufacture of fuel transportation pipes.

### Example 5

### Manufacture of a Masterbatch Containing a Solid Fluoro Elastomeric Resin Base

Solid particles of the VITON® A100 resin metered by a gravimetric feeder were introduced by means of a strip feeder into the first feed hopper of a Buss® MDK 46 co-kneader (L/D=11) equipped with an extrusion screw and a granulating device.

Carbon nanotubes (Graphistrength® C100 from Arkema) were introduced into the second feed zone, after the resin was liquified in the first zone of the co-kneader. The temperature set points inside the co-kneader were set at 150° C. in zone 1 and 140° C. in Zone 2 and the flow rate was set to 12 kg/h. The screw rotating speed was 200 rpm.

At the 4×4 mm die outlet, an homogeneous rod was obtained, which was chopped under a jet of water into granules constituted of a masterbatch containing 20% by weight of nanotubes. These granules were then dried at about 50° C. before being conditioned.

These granules may then be diluted in a polymer matrix containing a vulcanizing agent, and shaped.

1. Process for preparing a composite material containing more than 5% by weight, and up to 70% by weight, of nanotubes, comprising:
(a) the introduction, into a co-kneader, of a liquid polymer composition containing:
at least one elastomeric resin base that includes, or consists of, at least one thermosetting elastomeric base, and
carbon nanotubes,
(b) mixing of the polymer composition and the nanotubes in the said co-kneader, to form a composite material,
(c) recovery of the composite material, optionally after transformation into an agglomerated solid physical form.

2. Process according to claim 1, characterized in that the co-kneader has a screw ratio L/D ranging from 7 to 22 and more preferentially from 10 to 20.

3. Process according to claim 1, characterized in that the elastomeric resin base comprises, or even is formed from, one or more polymers chosen from: fluorocarbon or fluorosilicone polymers; nitrile resins; butadiene homopolymers and copolymers, optionally functionalized with unsaturated monomers such as maleic anhydride, (meth)acrylic acid and/or styrene (SBR); neoprene (or polychloroprene); polyisoprene; copolymers of isoprene with styrene, butadiene, acrylonitrile and/or methyl methacrylate; copolymers based on propylene and/or ethylene and especially terpolymers based on ethylene, propylene and dienes (EPDM), and also copolymers of these olefins with an alkyl(meth)acrylate or vinyl acetate; halogenated butyl rubbers; silicone resins; polyurethanes; polyesters; acrylic polymers such as poly(butyl acrylate) bearing carboxylic acid or epoxy functions; and also modified or functionalized derivatives thereof and mixtures thereof.

4. Process according to any claim 3, characterized in that the elastomer resin base includes, or is even formed from, one or more polymers chosen from: nitrile resins, in particular acrylonitrile and butadiene copolymers (NBR); silicone resins, in particular poly(dimethylsiloxanes) bearing vinyl groups; fluorocarbon polymers, in particular hexafluoropropylene (HFP) and vinylidene difluoride (VF2) copolymers; terpolymers of hexafluoropropylene (HFP), vinylidene difluoride (VF2) and tetrafluoroethylene (TFE), wherein each monomer may represent more than 0% and up to 80% of the terpolymer ; and mixtures thereof.

5. Process according to claim 1, characterized in that the composite material contains from 10% to 50% by weight, preferably from 20% to 50% by weight and more preferentially from 25% to 40% by weight of nanotubes relative to the total weight of the composite material.

6. Composite material or composite product that may be obtained according to the process according to claim 1.

7. A method for providing a polymer matrix at least one electrical, mechanical and/or thermal property, comprising including a composite material according to claim 6 in said polymer matrix.

8. Process for manufacturing a composite product, comprising:
the manufacture of a composite material according to the process according to claim 1, and
the introduction of the composite material into a polymer matrix.
